(19) United States
(12) Patent Application Publication
(10) Pub. No.: US 2020/0391607 A1
(43) Pub. Date: Dec. 17, 2020

(54) SYSTEMS AND METHODS FOR CHARGING MANAGEMENT OF CHARGING DEVICES

(71) Applicant: Noodoe Corporation, Taipei City (TW)

(72) Inventors: John C. Wang, Taipei City (TW); Te-Chuan Liu, Taipei City (TW)

(21) Appl. No.: 16/901,158

(22) Filed: Jun. 15, 2020

(30) Foreign Application Priority Data
Jun. 14, 2019 (TW) 108120760

(51) Int. Cl. B60L 53/62; B60L 53/67; B60L 53/64

(52) U.S. Cl. CPC B60L 53/62; B60L 53/64; B60L 53/67

(57) ABSTRACT

A charging management method is provided for managing the charging of electric vehicles by first and second charging devices connected to the same power supply equipment. The method is executed by the first charging device, wherein the method includes: obtaining power supply information corresponding to the power supply equipment; obtaining a first charging request, which requires the first charging device to output power for charging a first electric vehicle; obtaining a second charging request, which requires the second charging device to output power for charging a second electric vehicle; scheduling and controlling the charging of the first electric vehicle by the first charging device and the charging of the second electric vehicle by the second charging device according to vehicle-usage scheduling information specified by the first and second charging requests and the power supply information.

### BACKGROUND OF THE INVENTION

### Field of the Invention

The disclosure relates generally to charging management systems and methods thereof, and, more particularly to charging management systems and methods that can perform related managements for charging devices of electric vehicles.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

On the other hand, since it is costly to install new power supply equipment, the number of charging stations that can be installed on a specific site is limited by the maximum load capacity of the existing power supply equipment. Therefore, users may spend a lot of waiting time due to that the charging station is being occupied or need to waste time to find other charging stations for charging, resulting in inconvenience in use and reducing the willingness to use.

### BRIEF SUMMARY OF THE INVENTION

Charging management system and method for charging management of charging devices are provided, wherein power outputted by charging devices of electric vehicles are managed and more chargers can be installed without increasing additional power supply, thus making more efficient use of the power supply.

An embodiment of a charging management system is applied to a charging group that is powered by a power supply equipment. The charging group comprises: a first charging device which is configured to output electric power for charging a first electric vehicle in response to a first charging request, wherein the first charging request includes first vehicle-usage scheduling information; and a second charging device which is configured to output electric power for charging a second electric vehicle in response to a second charging request, wherein the second charging request includes second vehicle-usage scheduling information, wherein the first charging device and the second charging device are electrically connected to the power supply equipment, and the power supply equipment corresponds to preset power supply information, and the power supply information records a power load capacity of the power supply equipment. The first charging device performs charging schedule management of both the first charging device and the second charging device, comprising: a storage unit for storing the power supply information; and a processor which is configured to schedule and control the charging of the first electric vehicle by the first charging device and the charging of the second electric vehicle by the second charging device according to the first charging request, the second charging request, and the power supply information, such that the charging of the first electric vehicle and the charging of the second electric vehicle are completed without exceeding the power load capacity to meet the first vehicle-usage scheduling information and the second vehicle-usage scheduling information.

In an embodiment of a method for charging management of charging devices for use in a first charging device of a charging group, wherein the charging group comprises the first charging device and a second charging device electrically connected to a power supply equipment, the method comprises: obtaining power supply information corresponding to the power supply equipment, the power supply information recording a power load capacity of the power supply equipment; obtaining a first charging request, which requires the first charging device to output power for charging a first electric vehicle, wherein the first charging request includes first vehicle-usage scheduling information; obtaining a second charging request, which requires the second charging device to output power for charging a second electric vehicle, wherein the second charging request includes second vehicle-usage scheduling information; and scheduling and controlling the charging of the first electric vehicle by the first charging device and the charging of the second electric vehicle by the second charging device according to the first and second vehicle-usage scheduling information specified by the first and second charging requests, respectively, and the power supply information, such that the charging of the first electric vehicle and the charging of the second electric vehicle are completed without exceeding the power load capacity to meet the first vehicle-usage scheduling information and the second vehicle-usage scheduling information.

In some embodiments, the first vehicle-usage scheduling information records the time when the first electric vehicle is scheduled to be used, and the second vehicle-usage scheduling information records the time when the second electric vehicle is scheduled to be used.

In some embodiments, the first vehicle-usage scheduling information records a planned travel distance of the first electric vehicle, and the second vehicle-usage scheduling information records a planned travel distance of the second electric vehicle.

In some embodiments, the first vehicle-usage scheduling information records the demand for the desired charging amount of the first electric vehicle, and the second scheduled vehicle information records the demand for the desired charging amount of the second electric vehicle.

In some embodiments, the processor further generates a first instruction and a second instruction according to the first charging request, the second charging request and the power supply information, and then transmitted to the first charging device and the second charging device respectively, such that the first charging device outputs power to charge the first electric vehicle in response to the first instruction and the second charging device outputs power to charge the second electric vehicle in response to the second instruction. In one embodiment, the first instruction further includes a first charging control parameter for controlling the power output mode and size of the first charging device, and the second instruction further includes a second charging control parameter for controlling the power output mode and size of the second charging device.

In some embodiments, the first charging device obtains first battery information of the first electric vehicle and obtains second battery information of the second electric vehicle from the second electric vehicle, and the first electric vehicle further determines a remaining battery capacity of the first electric vehicle and a remaining battery capacity of the second electric vehicle based on the first battery information and the second battery information to control and schedule the charging of the first charging device to the first electric vehicle and the charging of the second charging device to the second electric vehicle such that the one with the lower remaining battery capacity between the first electric vehicle and the second electric vehicle is preferentially charged.

In some embodiments, the first charging device periodically obtains the remaining battery capacity from one of the first electric vehicle and the second electric vehicle currently being charged and determines whether the remaining battery capacity has reached a battery capacity threshold, and if so, the first charging device suspends the charging of the one of the first electric vehicle and the second electric vehicle currently being charged, and switches to charge the other one of the first electric vehicle and the second electric vehicle instead. In some embodiments, the first charging device further determines the remaining battery capacity of the first electric vehicle and the remaining battery capacity of the second electric vehicle based on the first battery information and the second battery information, and if the remaining battery capacity of one of the first electric vehicle or the second electric vehicle is lower than a minimum battery capacity threshold, the processor first charges the battery of the one with a remaining battery capacity lower than the minimum battery capacity threshold to reach the minimum battery capacity threshold, and then controls and schedules the charging of the first charging device to the first electric vehicle and the charging of the second charging device to the second electric vehicle.

In some embodiments, the power supply information further includes the time difference electricity price applicable to the power supply equipment, and wherein the first charging device further schedules and controls the first charging device to charge the first electric vehicle and the second charging device to charge the second electric device to minimum a total electricity price of the electric power used by the first charging device for charging the first electric vehicle and the second charging device for charging the second electric vehicle.

In some embodiments, wherein the first charging device further obtains charging fee information of the first charging device and the second charging device, and performs one of the following steps: calculating charging amount corresponding to the first charging request and the second charging request according to the charging information, and transmitting the calculated charging amount of the second charging request to the second charging device to charge accordingly; and calculating the charging amount corresponding to the first charging request according to the charging information and transmitting the charging information to the second charging device for the second charging device to calculate the charging amount corresponding to the second charging request. In some embodiments, the first charging request further includes first user information recording a user priority level corresponding to the first electric vehicle, and the second charging request further includes second user information recording a user priority level corresponding to the second electric vehicle, wherein the first charging device compares the user priority levels corresponding to the first electric vehicle and the second electric vehicle according to the first user information and the second user information, and schedules and controls the first charging device to charge the first electric vehicle and the second charging device to charge the second electric vehicle, such that the one with a higher priority between the first electric vehicle and the second electric vehicle is preferentially charged.

In some embodiments, wherein the first charging device comprises a plurality of charging connectors, and when the first electric vehicle is electrically connected with one of a plurality of charging connectors, a third electric vehicle is electrically connected with another one of the charging connectors, wherein the first charging device outputs electric power for charging a third electric vehicle in response to a third charging request, wherein the third charging request includes third vehicle-usage scheduling information, and the processor further schedules and controls the charging of the first electric vehicle and the third electric vehicle by the first charging device and the charging of the second electric vehicle by the second charging device according to the first charging request, the second charging request, the third charging request and the power supply information, such that the charging of the first electric vehicle, the third electric vehicle and the second electric vehicle are completed without exceeding the power load capacity to meet the first vehicle-usage scheduling information, the third vehicle-usage scheduling information and the second vehicle-usage scheduling information, respectively.

Methods for charging management of charging devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a charging management system of charging devices of the invention;

FIG. 2 is a schematic diagram illustrating another embodiment of a charging management system of charging devices of the invention;

FIG. 3 is a schematic diagram illustrating an embodiment of a charging device of the invention:

FIG. 4 is a flowchart of an embodiment of a method for charging management of charging devices of the invention; and

FIG. 5 is a flowchart of another embodiment of a method for charging management of charging devices of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide charging management systems and related methods for charging management of charging devices, which can exceed the limit of the maximum load capacity of an existing power supply equipment at a power supply point and set more charging stations. Moreover, with the charging management systems and related methods for charging management of charging devices of the invention, the existing power supply equipment can be used flexibly to avoid the addition of new power supply equipment, while suppressing the increase in equipment cost and meeting the power demand of the electric vehicle charging device, so as to avoid overloading of the power load. On the other hand, the increase in the number of charging stations can effectively reduce the waiting time spent by the user due to the occupation of the charging station or the time and spirit of looking for other charging stations, thus improving the user's experience and increasing the user's willingness to use related electric vehicle charging services. Moreover, with the present invention, parking places and other places can install more chargers without increasing additional power supply, thus making more efficient use of the power supply to provide better electric vehicle charging services.

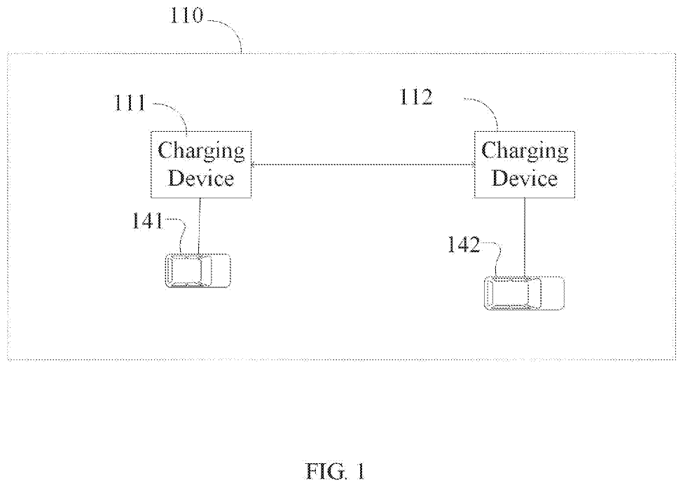

FIG. 1 is a schematic diagram illustrating an embodiment of a charging management system of charging devices of the invention. As shown in FIG. 1, the charging management system of charging devices 100 of the present invention comprises a charging device 111 and a charging device 112.

The charging device 111 and the charging device 112 belong to the same charging group 110. In some embodiments, the charging device 111 and the charging device 112 belonging to the same charging group 110 means that the charging device 111 and the charging device 112 are directly or indirectly electrically connected to the same power supply equipment (not shown). The power supply equipment corresponds to a preset power supply information, and the power supply information records a power load capacity of the power supply equipment. Therefore, the total power used by all charging devices (the charging device 111 and the charging device 112 in FIG. 1) in the charging group 110 does not exceed the power load capacity of the power supply equipment. In addition, the power supply information may also record the time difference electricity price of the power supply equipment, such as, different electricity prices applied to the peak time and the off-peak time for using power.

The charging device 111 is used to output electric power to power the electric vehicle 141 in response to a first charging request, wherein the first charging request includes a first vehicle-usage scheduling information, which may at least record the time when the electric vehicle 141 is scheduled to be used, a planned travel distance of the electric vehicle 141, the demand for the desired charging amount of the electric vehicle 141, and so on. Similarly, the charging device 112 is used to output electric power to charge the electric vehicle 142 in response to a second charging request, wherein the second charging request includes a second vehicle-usage scheduling information, which records the time when the electric vehicle 142 is scheduled to be used, a planned travel distance of the electric vehicle 142, the demand for the desired charging amount of the electric vehicle 142, and so on.

The first charging request may further include other information, such as a first user information corresponding to the electric vehicle 141, which is used to record a user priority level for the first user. Similarly, the second charging request may also include other information, such as a second user information corresponding to the electric vehicle 142, which is used to record a user priority level for the second user. For example, those users with higher user priority levels can use charging resources first.

In some embodiments, the charging device 111 and the charging device 112 are connected to each other in a wired manner. In an environment without a wireless network such as a telecommunications network or a Wi-Fi network, the charging device 111 and the charging device 112 can also transmit information between each other.

The charging device 111 obtains the power load capacity corresponding to the power supply equipment, the first charging request corresponding to the charging device 111 and the second charging request corresponding to the charging device 112, and schedules and controls the charging of the electric vehicle 141 by the charging device 111 and the charging of the electric vehicle 142 by the charging device 112 according to the first charging request, the second charging request, and the power supply information, such that the charging of the electric vehicle 141 and the charging of the electric vehicle 142 can be completed without exceeding the power load capacity to meet the first vehicle-usage scheduling information and the second vehicle-usage scheduling information.

In some embodiments, the charging device 111 can use the time difference electricity price in the power supply information to schedule and control the charging device 111 to charge the electric vehicle 141 and the charging device 112 to charge the electric device 142 to minimum a total electricity price of the electric power used by the charging device 111 for charging the electric vehicle 141 and the charging device 112 for charging the electric vehicle 142.

In other embodiments, the charging device 111 may use the user priority levels recorded in the first user information of the first charging request and the second user information of the second charging request, compare the user priority levels corresponding to the electric vehicle 141 and the electric vehicle 142 according to the first user information and the second user information, and schedule and control the charging device 111 to charge the electric vehicle 141 and the charging device 112 to charge the electric device 142, such that the one with a higher priority between the electric vehicle 141 and the electric vehicle 142 is preferentially charged.

In other embodiments, the charging device 111 obtains the first battery information of the electric vehicle 141 and obtains the second battery information of the electric vehicle 142 via the charging device 112. The first battery information and the second battery information may include information such as the remaining battery capacity and battery temperature of the corresponding electric vehicle. The charging device 111 determines the remaining battery power corresponding to the electric vehicle 141 and the remaining battery power corresponding to the electric vehicle 142 according to the first battery information and the second batter information, and schedules and controls the charging device 111 to charge the electric vehicle 141 and the charging device 112 to charge the electric device 142, such that the one with the lower remaining battery capacity between the electric vehicle 141 and the electric vehicle 142 is preferentially charged.

As long as the electric vehicle 141 and the electric vehicle 142 are charged to meet the first vehicle-usage scheduling information and the second vehicle-usage scheduling information without exceeding the electrical load capacity, different scheduling control logics can be used by the charging device 111. In some embodiments, when the scheduled time when the electric vehicle 141 is scheduled to be used is earlier that of the electric vehicle 142, the charging device 111 may first charge the electric vehicle 141, and then instruct the charging device 112 to charge the electric vehicle 142 after the charging of the electric vehicle 141 is completed. In some other embodiments, when the scheduled time when the electric vehicle 141 is scheduled to be used is earlier than that of the electric vehicle 142, the charging device 111 may first charge the electric vehicle 141. After charging starts, the charging device 111 periodically obtains the remaining battery capacity of the electric vehicle 141 currently being charged, and determines whether the remaining battery capacity of the electric vehicle 141 reaches has reached a preset battery capacity threshold (for example, the remaining battery capacity reaches 50% of the battery capacity). If so, the charging device 111 suspends the charging of the electric vehicle 141 and instructs the charging device 112 to starting the charging of the electric vehicle 142 instead.

In other embodiments, the charging device 111 may determine the remaining battery capacity corresponding to the electric vehicle 141 and the remaining battery capacity corresponding to the electric vehicle 142 according to the first battery information and the second battery information, and if the remaining battery capacity of either one of the electric vehicle 141 or the electric vehicle 142 is lower than a minimum battery capacity threshold (for example, the remaining battery capacity reaches 30% of the battery capacity), the charging device 111 charges the battery of the one with a remaining battery capacity lower than the minimum battery capacity threshold to reach the minimum battery capacity threshold first no matter which electric vehicle corresponds to earlier scheduled using time. After the remaining battery power of all electric vehicles had reached the minimum power threshold, the charging device 111 schedules and controls the charging device 111 to charge the electric vehicle 141 and the charging device 112 to charge the electric device 142.

In some embodiments, the charging device 111 further obtains charging fee information of the charging device 111 and the charging device 112, and performs one of the following steps: calculating charging amount corresponding to the first charging request and the second charging request according to the charging information, and transmitting the calculated charging amount of the second charging request to the charging device 112 to charge accordingly; and calculating the charging amount corresponding to the first charging request according to the charging information and transmitting the charging information to the charging device 112 for the charging device 112 to calculate the charging amount corresponding to the second charging request.

When performing the charging schedule control, the charging device 111 may output power to the electric vehicle 141 (for example, an electric scooters or an electric car) which is electronically connected to the charging device 111 or prohibit the charging device 111 from outputting power to the electric vehicle 141. Similarly, the charging device 111 may generate an instruction and transmit it to the charging device 112, so as to allow the charging device 112 to output power to the electric vehicle 142 (for example, an electric scooters or an electric car) which is electronically connected to the charging device 112 or prohibit the charging device 112 from outputting power to the electric vehicle 142.

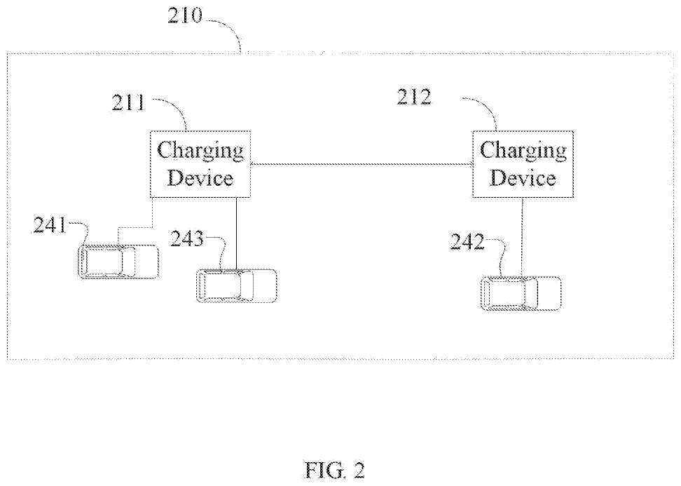

FIG. 2 is a schematic diagram illustrating another embodiment of a charging management system of charging devices of the invention. As shown in FIG. 2, the charging management system 200 of the charging device according to the embodiment of the invention may comprise a charging device 211 and a charging device 212.

The charging device 211 and the charging device 212 belong to the same charging group 210. In some embodiments, the charging device 211 and the charging device 212 belonging to the same charging group 210 means that the charging device 211 and the charging device 212 are directly or indirectly electrically connected to the same power supply equipment. The power supply equipment corresponds to a preset power supply information, and the power supply information records a power load capacity of the power supply equipment. Therefore, the total power used by all charging devices (the charging device 211 and the charging device 212 in FIG. 2) in the charging group 210 does not exceed the power load capacity of the power supply equipment. In addition, the power supply information may also record the time difference electricity price of the power supply equipment, such as, different electricity prices applied to the peak time and the off-peak time for using power.

The charging device 211 is used to output electric power to power the electric vehicle 241 in response to a first charging request, wherein the first charging request includes a first vehicle-usage scheduling information, which may at least record the time when the electric vehicle 241 is scheduled to be used, a planned travel distance of the electric vehicle 241, the demand for the desired charging amount of the electric vehicle 241, and so on. The charging device 211 may include a plurality of charging connectors (e.g., charging cables) that meet the same charging interface specifications. When the electric vehicle 241 is electrically connected to one of the charging connectors, an electric vehicle 243 is electrically connected to another one of the charging connectors. At this time, the charging device 211 outputs electric power for charging the electric vehicle 243 in response to a third charging request, wherein the third charging request includes third vehicle-usage scheduling information, which may at least record the time when the electric vehicle 243 is scheduled to be used, a planned travel distance of the electric vehicle 243, the demand for the desired charging amount of the electric vehicle 243, and so on. The charging device 211 may also include a plurality of charging connectors that meet different charging interface specifications.

Similarly, the charging device 212 is used to output electric power to charge the electric vehicle 242 in response to a second charging request, wherein the second charging request includes a second vehicle-usage scheduling information, which records the time when the electric vehicle 242 is scheduled to be used, a planned travel distance of the electric vehicle 242, the demand for the desired charging amount of the electric vehicle 242, and so on.

The first charging request may further include other information, such as a first user information corresponding to the electric vehicle 241, which is used to record a user priority level for the first user. The third charging request may further include other information, such as a third user information corresponding to the electric vehicle 243, which is used to record a user priority level for the third user. Similarly, the second charging request may also include other information, such as a second user information corresponding to the electric vehicle 242, which is used to record a user priority level for the second user. For example, those users with higher user priority levels can use charging resources first.

In some embodiments, the charging device 211 and the charging device 212 are connected to each other in a wired manner. In an environment without a wireless network such as a telecommunications network or a Wi-Fi network, the charging device 211 and the charging device 212 can also transmit information between each other.

The charging device 211 obtains the power load capacity corresponding to the power supply equipment, the first charging request and the third charging request corresponding to the charging device 211 and the second charging request corresponding to the charging device 212, and schedules and controls the charging of the electric vehicle 241 and the electric vehicle 243 by the charging device 211 and the charging of the electric vehicle 242 by the charging device 212 according to the first charging request, the third charging request, the second charging request, and the power supply information, such that the charging of the electric vehicle 241, the electric vehicle 243 and the electric vehicle 242 can be completed without exceeding the power load capacity to meet the first vehicle-usage scheduling information, the third vehicle-usage scheduling information and the second vehicle-usage scheduling information, respectively.

In some embodiments, the charging device 211 can use the time difference electricity price in the power supply information to schedule and control the charging device 211 to charge the electric vehicle 241 and the electric vehicle 243 and the charging device 212 to charge the electric device 242 to minimum a total electricity price of the electric power used by the charging device 211 for charging the electric vehicle 241 and the electric vehicle 243 and the charging device 212 for charging the electric vehicle 242.

In other embodiments, the charging device 211 may use the user priority levels recorded in the first user information of the first charging request, the user priority levels recorded in the third user information of the third charging request and the second user information of the second charging request, compare the user priority levels corresponding to the electric vehicle 241, the electric vehicle 243 and the electric vehicle 242 according to the first user information, the third user information and the second user information, and schedule and control the charging device 211 to charge the electric vehicle 241 and the electric vehicle 243 and the charging device 212 to charge the electric device 242, such that the one with a higher priority among the electric vehicle 241, the electric vehicle 243 and the electric vehicle 242 is preferentially charged.

In other embodiments, the charging device 211 obtains the first battery information of the electric vehicle 241, the third battery information of the electric vehicle 243 and the second battery information of the electric vehicle 242 via the network 230. The first battery information, the third battery information and the second battery information may include information such as the remaining battery capacity, battery temperature and so on of the corresponding electric vehicle. The charging device 211 determines the remaining battery power corresponding to the electric vehicle 241, the remaining battery power corresponding to the electric vehicle 243 and the remaining battery power corresponding to the electric vehicle 242 according to the first battery information, the third battery information and the second battery information, and schedules and controls the charging device 211 to charge the electric vehicle 241 and the electric vehicle 243 and the charging device 212 to charge the electric device 242, such that the one with the lower remaining battery capacity among the electric vehicle 241, the electric vehicle 243 and the electric vehicle 242 is preferentially charged.

As long as the electric vehicle 241, the electric vehicle 243 and the electric vehicle 242 are charged to meet the first vehicle-usage scheduling information, the third vehicle-usage scheduling information and the second vehicle-usage scheduling information, respectively, without exceeding the electrical load capacity, different scheduling control logics can be used by the charging device 211. In some embodiments, when the scheduled time when the electric vehicle 241 is scheduled to be used is earlier than that of the electric vehicle 242 and the electric vehicle 243, the charging device 211 may first instruct the charging device 211 to charge the electric vehicle 241, and then charge the one with second earlier scheduled time among remaining vehicles after the charging of the electric vehicle 241 is completed. In some other embodiments, when the scheduled time when the electric vehicle 241 is scheduled to be used is earlier than that of the electric vehicle 242 and the electric vehicle 243, the charging device 211 may first instruct the charging device 211 to charge the electric vehicle 241. After charging starts, the charging device 211 periodically obtains the remaining battery capacity of the electric vehicle 241 currently being charged through the network 230, and determines whether the remaining battery capacity of the electric vehicle 241 reaches has reached a preset battery capacity threshold (for example, the remaining battery capacity reaches 50%-o of the battery capacity). If so, the charging device 211 instructs the charging device 211 to suspend the charging of the electric vehicle 241 and starts the charging of the one with second earlier scheduled time among remaining vehicles instead.

In other embodiments, the charging device 211 may determine the remaining battery capacity corresponding to the electric vehicle 241, the electric vehicle 243 and the electric vehicle 242 according to the first battery information, the third battery information and the second battery information, and if the remaining battery capacity of any of the electric vehicle 241, the electric vehicle 243 or the electric vehicle 242 is lower than a minimum battery capacity threshold (for example, the remaining battery capacity reaches 30% of the battery capacity), the charging device 211 charges the battery of the one with a remaining battery capacity lower than the minimum battery capacity threshold to reach the minimum battery capacity threshold first no matter which electric vehicle corresponds to earlier scheduled using time. After the remaining battery power of all electric vehicles had reached the minimum power threshold, the charging device 211 schedules and controls the charging device 211 to charge the electric vehicle 241, the electric vehicle 243 and the charging device 212 to charge the electric device 242.

In some embodiments, the charging device 211 further obtains charging fee information of the charging device 211 and the charging device 212, and performs one of the following steps: calculating charging amount corresponding to the first charging request, the third charging request and the second charging request according to the charging information, and transmitting the calculated charging amount of the second charging request to the charging device 112 to charge accordingly; and calculating the charging amount corresponding to the first charging request and the third charging request according to the charging information and transmitting the charging information to the charging device 112 for the charging device 112 to calculate the charging amount corresponding to the second charging request.

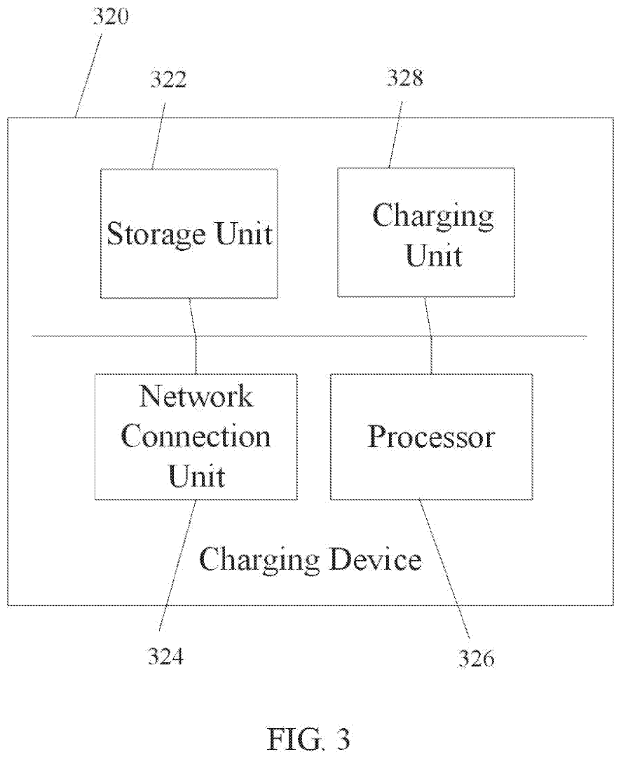

FIG. 3 is a schematic diagram illustrating an embodiment of a charging device of the invention. The charging device shown in FIG. 3 can be applied to the charging device 111 and 211, which has the processing computing ability to perform the charging management operations of each charging device belonging to a charging group, and has the function of network connection in order to receive, download or update the various parameters and information required for charging management operations.

The charging device 320 at least comprises a storage unit 322, a network connection unit 324, a processor 326, and a charging unit 328. The network connection unit 324 can receive, download, or update various parameters and information required by the charging management operation via a network, such as a wired network, a telecommunications network, and a wireless network, such as a Wi-Fi network.

The storage unit 322 (e.g., a memory) can store and record related data, such as charging device information for charging devices included in the charging group, power supply information corresponding to the power supply equipment, and charging request information. It is noted that, above data is merely examples of the application, and the present invention is not limited thereto. The processor 326 can control related operations of software and hardware in the charging device 320 to perform the method for charging management of charging devices of the invention, the details of which will be described later. For example, the processor 326 can be a general-purpose controller, a micro-control unit (MCU), a digital signal processor (DSP), or the like, which provides the function of data analyzing, processing, and computing. However, it is understood that the present invention is not limited thereto. The charging unit 328 includes a plurality of charging connectors (for example, charging cables) that meet the same charging interface specifications or different charging interface specifications, which are electrically connected to the electric vehicle, and output power to the electric vehicle according to instructions of the processor 326.

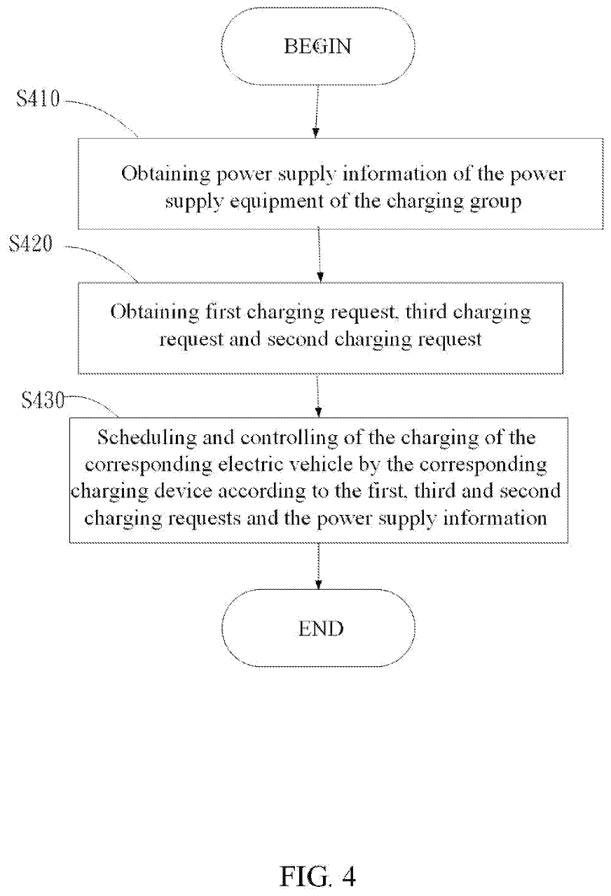

FIG. 4 is a flowchart of an embodiment of a method for charging management of charging devices of the invention. The method for charging management of charging devices of the invention can be used in a charging device, such as the charging device 111 as shown in FIG. 1, and performed by the processor of the charging device 111. According to the method of this embodiment, the charging group 110 includes a charging device 111 and a charging device 112 that are electrically connected to the power supply equipment. For example, the charging device 111 and the charging device 112 may be electric vehicle chargers, which are provided with a single charging connector, and output electric power through the charging connector to power the vehicle for charging. The charging connectors of the charging device 111 and the charging device 112 may be charging cables that meet the same charging interface specifications, or charging cables that meet different charging interface specifications.

First, in step S410, power supply information corresponding to a power supply equipment is obtained. The power supply information corresponding to the power supply equipment can be obtained in any manner. For example, the power supply information can be obtained through the network using a network connection module or read from the storage unit. In one embodiment, the power supply information records a power load capacity of the power supply equipment, but it is not limited thereto. In another embodiment, the power supply information may also record the time difference electricity price of the power supply equipment, such as, different electricity prices applied to the peak time and the off-peak time for using power.

In step S420, all charging requests corresponding to the charging group 110 are obtained through the network, in this example, the first charging request and the second charging request. The first charging request is used to request the charging device 111 to output electric power to the electric vehicle 141 for charging, wherein the first charging request includes first vehicle-usage scheduling information, which may at least record the time when the electric vehicle 141 is scheduled to be used, a planned travel distance of the electric vehicle 141, the demand for the desired charging amount of the electric vehicle 141, and so on. The second charging request is used to request the charging device 112 to output electric power to the electric vehicle 142 for charging, wherein the second charging request includes second vehicle-usage scheduling information, which may at least record the time when the electric vehicle 142 is scheduled to be used, a planned travel distance of the electric vehicle 142, the demand for the desired charging amount of the electric vehicle 142, and so on.

For example, the processor further generates a first instruction and a second instruction according to the first charging request, the second charging request and the power supply information, and then transmitted to the charging device 111 and the charging device 112 respectively, such that the charging device 111 outputs power to charge the electric vehicle 141 in response to the first instruction and the charging device 112 outputs power to charge the electric vehicle 142 in response to the second instruction. In one embodiment, the first instruction further includes a first charging control parameter for controlling the power output mode and size of the charging device 111, and the second instruction further includes a second charging control parameter for controlling the power output mode and size of the charging device 112, such as the charging speed is fast or slow, the charging time interval and so on.

Next, in step S430, the charging of the electric vehicle 141 by the charging device 111 and the charging of the electric vehicle 142 by the charging device 112 are scheduled and controlled according to the obtained first and second charging requests and the power supply information, such that the charging of the electric vehicle 141 and the charging of the electric vehicle 142 are completed without exceeding the power load capacity to meet the first vehicle-usage scheduling information and the second vehicle-usage scheduling information.

As long as the electric vehicle 141 and the electric vehicle 142 are charged to meet the first vehicle-usage scheduling information and the second vehicle-usage scheduling information without exceeding the electrical load capacity, different scheduling control logics can be used in step S430. In some embodiments, when the scheduled time when the electric vehicle 141 is scheduled to be used is earlier than that of the electric vehicle 142, the charging device 111 is first instructed to charge the electric vehicle 141, and the charging device 112 is then instructed to charge the electric vehicle 142 after the charging of the electric vehicle 141 is completed in step S430.

In some embodiments, in step S420, the battery information corresponding to all the electric vehicles in the charging group 110 may also be obtained through the network, in this example, the first battery information of the electric vehicle 141 and the second battery information of the electric vehicle 142. The first battery information and the second battery information may include information such as the remaining battery capacity and battery temperature of the corresponding electric vehicle. The performance in step S430 may determine the remaining battery capacity corresponding to the electric vehicle 141 and the remaining battery capacity corresponding to the electric vehicle 142 according to the first battery information and the second battery information, and schedules and controls the charging device 111 to charge the electric vehicle 141 and the charging device 112 to charge the electric device 142, such that the one with the lower remaining battery capacity between the electric vehicle 141 and the electric vehicle 142 is preferentially charged.

In some embodiments, when the scheduled time when the electric vehicle 141 is scheduled to be used is earlier than that of the electric vehicle 142, the charging device 111 may first charge the electric vehicle 141. After charging starts, the charging device 111 periodically obtains the remaining battery capacity of the electric vehicle 141 currently being charged through the network 130, and determines whether the remaining battery capacity of the electric vehicle 141 reaches has reached a preset battery capacity threshold (for example, the remaining battery capacity reaches 50% of the battery capacity). If so, the charging device 111 suspends the charging of the electric vehicle 141 and instructs the charging device 112 to starting the charging of the electric vehicle 142 instead.

In other embodiments, the charging device 111 may determine the remaining battery capacity corresponding to the electric vehicle 141 and the remaining battery capacity corresponding to the electric vehicle 142 according to the first battery information and the second battery information, and if the remaining battery capacity of either one of the electric vehicle 141 or the electric vehicle 142 is lower than a minimum battery capacity threshold (for example, the remaining battery capacity reaches 30% of the battery capacity), the charging device 111 charges the battery of the one with a remaining battery capacity lower than the minimum battery capacity threshold to reach the minimum battery capacity threshold first no matter which electric vehicle corresponds to earlier scheduled using time. After the remaining battery power of all electric vehicles had reached the minimum power threshold, the charging device 111 schedules and controls the charging device 111 to charge the electric vehicle 141 and the charging device 112 to charge the electric device 142.

In some embodiments, the time difference electricity price in the power supply information can be used in step S430 to schedule and control the charging device 111 to charge the electric vehicle 141 and the charging device 112 to charge the electric device 142 to minimum a total electricity price of the electric power used by the charging device 111 for charging the electric vehicle 141 and the charging device 112 for charging the electric vehicle 142.

In other embodiments, the user priority levels recorded in the first user information of the first charging request and the second user information of the second charging request can be used in step S430 to compare the user priority levels corresponding to the electric vehicle 141 and the electric vehicle 142 according to the first user information and the second user information, and schedule and control the charging device 111 to charge the electric vehicle 141 and the charging device 112 to charge the electric device 142, such that the one with a higher priority between the electric vehicle 141 and the electric vehicle 142 is preferentially charged.

In some embodiments, the charging device 111 further obtains charging fee information of the charging device 111 and the charging device 112 in step S430 to perform one of the following steps: calculating charging amount corresponding to the first charging request and the second charging request according to the charging information, and transmitting the calculated charging amount of the second charging request to the charging device 112 to charge accordingly; and calculating the charging amount corresponding to the first charging request according to the charging information and transmitting the charging information to the charging device 112 for the charging device 112 to calculate the charging amount corresponding to the second charging request.

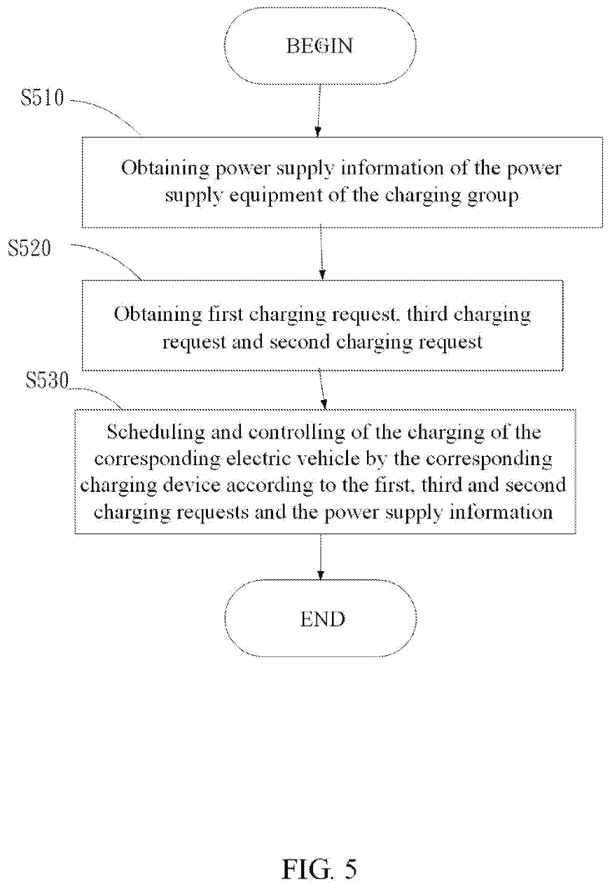

FIG. 5 is a flowchart of an embodiment of a method for charging management of charging devices of the invention. The method for charging management of charging devices of the invention can be used in a charging device, such as the charging device 211 as shown in FIG. 2, and performed by the processor of the charging device 211. According to the method of this embodiment, the charging group 210 includes a charging device 211 and a charging device 212 that are electrically connected to the same power supply equipment. For example, the charging device 211 and the charging device 212 may be electric vehicle chargers, which are provided with a plurality of charging connectors (e.g., the charging cables), and output electric power through the charging connectors to the vehicles for charging. When the charging device has a plurality of charging connectors, the charging connectors of the charging devices electrically connected to the same power supply equipment may be charging cables that meet the same charging interface specifications, or charging cables that meet different charging interface specifications. The number of charging connectors provided in the charging device is not limited to two only. It can be configured with more charging connectors according to the actual situation.

First, in step S510, power supply information corresponding to a power supply equipment is obtained. The power supply information corresponding to the power supply equipment can be obtained in any manner. For example, the power supply information can be obtained through the network using a network connection module or it may be prestored information read from the storage unit. In one embodiment, the power supply information records a power load capacity of the power supply equipment, but it is not limited thereto. In another embodiment, the power supply information may also record the time difference electricity price of the power supply equipment, such as, different electricity prices applied to the peak time and the off-peak time for using power.

In step S520, all charging requests corresponding to the charging group 210 are obtained through the network, in this example, the first charging request, the third charging request, and the second charging request. The first charging request is used to request the charging device 211 to output electric power to the electric vehicle 241 for charging, wherein the first charging request includes first vehicle-usage scheduling information, which may at least record the time when the electric vehicle 241 is scheduled to be used, a planned travel distance of the electric vehicle 241, the demand for the desired charging amount of the electric vehicle 241, and so on. The third charging request is used to request the charging device 211 to output electric power to the electric vehicle 243 for charging, wherein the third charging request includes third vehicle-usage scheduling information, which may at least record the time when the electric vehicle 243 is scheduled to be used, a planned travel distance of the electric vehicle 243, the demand for the desired charging amount of the electric vehicle 243, and so on. The second charging request is used to request the charging device 212 to output electric power to the electric vehicle 242 for charging, wherein the second charging request includes second vehicle-usage scheduling information, which may at least record the time when the electric vehicle 242 is scheduled to be used, a planned travel distance of the electric vehicle 242, the demand for the desired charging amount of the electric vehicle 242, and so on.

Next, in step S530, the charging of the electric vehicle 241 and the electric vehicle 243 by the charging device 211 and the charging of the electric vehicle 242 by the charging device 212 are scheduled and controlled according to the obtained first. third and second charging requests and the power supply information, such that the charging of the electric vehicle 241 and the electric vehicle 243 and the charging of the electric vehicle 242 are completed without exceeding the power load capacity to meet the first vehicle-usage scheduling information, the third vehicle-usage scheduling information and the second vehicle-usage scheduling information.

For example, the processor further generates a first instruction, a third instruction and a second instruction according to the first charging request, the third charging request, the second charging request and the power supply information, and then transmitted to the charging device 211 and the charging device 212 respectively, such that the charging device 211 outputs power to charge the electric vehicle 241 in response to the first instruction and outputs power to charge the electric vehicle 243 in response to the third instruction and the charging device 212 outputs power to charge the electric vehicle 242 in response to the second instruction. In one embodiment, the first instruction further includes a first charging control parameter for controlling the power output mode and size of the charging device 211, the third instruction further includes a third charging control parameter for controlling the power output mode and size of the charging device 211, and the second instruction further includes a second charging control parameter for controlling the power output mode and size of the charging device 212, such as the charging speed is fast or slow, the charging time interval and so on.

As long as the electric vehicle 241, the electric vehicle 243 and the electric vehicle 242 are charged to meet the first vehicle-usage scheduling information, the third vehicle-usage scheduling information and the second vehicle-usage scheduling information, respectively, without exceeding the electrical load capacity, different scheduling control logics can be used in step S530. In some embodiments, when the scheduled time when the electric vehicle 241 is scheduled to be used is earlier than that of the electric vehicle 242 and the electric vehicle 243, in step S530, the charging device 211 is first instructed to charge the electric vehicle 241, and then charge the one with second earlier scheduled time among remaining vehicles after the charging of the electric vehicle 241 is completed.

In some embodiments, in step S520, the battery information corresponding to all the electric vehicles in the charging group 210 may also be obtained through the network, in this example, the first battery information of the electric vehicle 241, the third battery information of the electric vehicle 243 and the second battery information of the electric vehicle 242. The first battery information, the third battery information and the second battery information may include information such as the remaining battery capacity and battery temperature of the corresponding electric vehicle. The performance in step S530 may determine the remaining battery power corresponding to the electric vehicle 241, the remaining battery power corresponding to the electric vehicle 243 and the remaining battery power corresponding to the electric vehicle 242 according to the first battery information, the third battery information and the second battery information, and schedules and controls the charging device 211 to charge the electric vehicle 241 and the electric vehicle 243 and the charging device 212 to charge the electric device 242, such that the one with the lower remaining battery capacity among the electric vehicle 241, the electric vehicle 243 and the electric vehicle 242 is preferentially charged.

In some embodiments, when the scheduled time when the electric vehicle 241 is scheduled to be used is earlier than that of the electric vehicle 242 and the electric vehicle 243, the charging unit of the charging device 211 is first instructed to charge the electric vehicle 241, and then charge the one with second earlier scheduled time among remaining vehicles after the charging of the electric vehicle 241 is completed. In some other embodiments, when the scheduled time when the electric vehicle 241 is scheduled to be used is earlier than that of the electric vehicle 242 and the electric vehicle 243, the charging unit of the charging device 211 is first instructed to charge the electric vehicle 241. After charging starts, the remaining battery capacity of the electric vehicle 241 currently being charged is periodically obtained, and it is determined whether the remaining battery capacity of the electric vehicle 241 reaches has reached a preset battery capacity threshold (for example, the remaining battery capacity reaches 50% of the battery capacity). If so, the charging unit of the charging device 211 is first instructed to suspend the charging of the electric vehicle 241 and then the charging unit of the charging device 211 is instructed to perform the charging of the electric vehicle 243 or the charging unit of the charging device 212 is instructed to perform the charging of the electric vehicle 242 instead.

In other embodiments, the charging device 211 may determine the remaining battery capacity corresponding to the electric vehicle 241, the electric vehicle 243 and the electric vehicle 242 according to the first battery information, the third battery information and the second battery information, and if the remaining battery capacity of any of the electric vehicle 241, the electric vehicle 243 or the electric vehicle 242 is lower than a minimum battery capacity threshold (for example, the remaining battery capacity reaches 30% of the battery capacity), the charging device 211 charges the battery of the one with a remaining battery capacity lower than the minimum battery capacity threshold to reach the minimum battery capacity threshold first no matter which electric vehicle corresponds to earlier scheduled using time. After the remaining battery power of all electric vehicles had reached the minimum power threshold, the charging device 211 schedules and controls the charging device 211 to charge the electric vehicle 241, the electric vehicle 243 and the charging device 212 to charge the electric device 242.

In some embodiments, the time difference electricity price in the power supply information can be used in step S530 to schedule and control the charging device 211 to charge the electric vehicle 241 and the electric vehicle 243 and the charging device 212 to charge the electric device 242 to minimum a total electricity price of the electric power used by the charging device 211 for charging the electric vehicle 241 and the electric vehicle 243 and the charging device 212 for charging the electric vehicle 242.

In other embodiments, the user priority levels recorded in the first user information of the first charging request, the user priority levels recorded in the third user information of the third charging request and the second user information of the second charging request can be used in step S530 to compare the user priority levels corresponding to the electric vehicle 241, the electric vehicle 243 and the electric vehicle 242 according to the first user information, the third user information and the second user information, and schedule and control the charging device 211 to charge the electric vehicle 241 and the electric vehicle 243 and the charging device 212 to charge the electric device 242, such that the one with a higher priority among the electric vehicle 241, the electric vehicle 243 and the electric vehicle 242 is preferentially charged.

In some embodiments, the charging device 211 further obtains charging fee information of the charging device 211 and the charging device 212, and performs one of the following steps: calculating charging amount corresponding to the first charging request, the third charging request and the second charging request according to the charging information, and transmitting the calculated charging amount of the second charging request to the charging device 112 to charge accordingly; and calculating the charging amount corresponding to the first charging request and the third charging request according to the charging information and transmitting the charging information to the charging device 112 for the charging device 112 to calculate the charging amount corresponding to the second charging request.

Therefore, the charging management systems and methods for charging management of charging devices thereof of the present invention can instruct the charging devices whether and when to output power to charge the electric vehicles according to the power supply information of the power supply equipment, the charging requests received by all the charging device in a same charging group, and the battery information for the electric vehicles as the charging objects of the corresponding charging group by one of the charging device of the charging group in an environment without a wireless network such as a telecommunication network or a Wi-Fi network, thereby using the electric power supply to provide electric vehicle charging service more effectively.

Methods for charging management of charging devices, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging management system, comprising:
a first charging device configured to output electric power for charging a first electric vehicle in response to a first charging request, wherein the first charging request includes first vehicle-usage scheduling information; and
a second charging device configured to output electric power for charging a second electric vehicle in response to a second charging request, wherein the second charging request includes second vehicle-usage scheduling information,
wherein the first charging device and the second charging device are electrically connected to a power supply equipment, and the power supply equipment corresponds to preset power supply information, and the power supply information records a power load capacity of the power supply equipment;
the first charging device further comprising:
a storage unit configured to store the power supply information; and
a processor configured to schedule and control the charging of the first electric vehicle by the first charging device and the charging of the second electric vehicle by the second charging device according to the first charging request, the second charging request, and the power supply information, such that the charging of the first electric vehicle and the charging of the second electric vehicle are completed without exceeding the power load capacity to meet the first vehicle-usage scheduling information and the second vehicle-usage scheduling information.

2. The charging management system of claim 1, wherein the first vehicle-usage scheduling information and the second vehicle-usage scheduling information comprise at least one of the following information:
the first vehicle-usage scheduling information records the time when the first electric vehicle is scheduled to be used, and the second vehicle-usage scheduling information records the time when the second electric vehicle is scheduled to be used;
the first vehicle-usage scheduling information records a planned travel distance of the first electric vehicle, and the second vehicle-usage scheduling information records a planned travel distance of the second electric vehicle; and
the first vehicle-usage scheduling information records the demand for the desired charging amount of the first electric vehicle, and the second scheduled vehicle information records the demand for the desired charging amount of the second electric vehicle.

3. The charging management system of claim 1, wherein the processor obtains first battery information of the first electric vehicle, and obtains second battery information of the second electric vehicle through the second charging device; wherein the processor further determines a remaining battery capacity of the first electric vehicle and a remaining battery capacity of the second electric vehicle based on the first battery information and the second battery information to control and schedule the charging of the first charging device to the first electric vehicle and the charging of the second charging device to the second electric vehicle such that the one with the lower remaining battery capacity between the first electric vehicle and the second electric vehicle is preferentially charged.

4. The charging management system of claim 3, wherein the processor periodically obtains the remaining battery capacity from one of the first electric vehicle and the second electric vehicle currently being charged and determines whether the remaining battery capacity has reached a battery capacity threshold, and if so, the processor suspends the charging of the one of the first electric vehicle and the second electric vehicle currently being charged, and switches to charge the other one of the first electric vehicle and the second electric vehicle instead.

5. The charging management system of claim 3, wherein the processor further determines the remaining battery capacity of the first electric vehicle and the remaining battery capacity of the second electric vehicle based on the first battery information and the second battery information, and if the remaining battery capacity of one of the first electric vehicle or the second electric vehicle is lower than a minimum battery capacity threshold, the processor first charges the battery of the one with a remaining battery capacity lower than the minimum battery capacity threshold to reach the minimum battery capacity threshold, and then controls and schedules the charging of the first charging device to the first electric vehicle and the charging of the second charging device to the second electric vehicle.

6. The charging management system of claim 1, wherein the power supply information further includes the time difference electricity price applicable to the power supply equipment, and wherein the processor further schedules and controls the first charging device to charge the first electric vehicle and the second charging device to charge the second electric device to minimum a total electricity price of the electric power used by the first charging device for charging the first electric vehicle and the second charging device for charging the second electric vehicle.

7. The charging management system of claim 1, wherein the first charging device further obtains charging fee information of the first charging device and the second charging device, and performs one of the following steps:
calculating charging amount corresponding to the first charging request and the second charging request according to the charging information, and transmitting the calculated charging amount of the second charging request to the second charging device to charge accordingly; and
calculating the charging amount corresponding to the first charging request according to the charging information and transmitting the charging information to the second charging device for the second charging device to calculate the charging amount corresponding to the second charging request.

8. The charging management system of claim 1, wherein the first charging request further includes first user information recording a user priority level corresponding to the first electric vehicle, and the second charging request further includes second user information recording a user priority level corresponding to the second electric vehicle, wherein the processor compares the user priority levels corresponding to the first electric vehicle and the second electric vehicle according to the first user information and the second user information, and schedules and controls the first charging device to charge the first electric vehicle and the second charging device to charge the second electric vehicle, such that the one with a higher priority between the first electric vehicle and the second electric vehicle is preferentially charged.

9. The charging management system of claim 1, wherein the first charging device comprises a plurality of charging connectors, and when the first electric vehicle is electrically connected with one of the plurality of charging connectors, a third electric vehicle is electrically connected with another one of the charging connectors, wherein the first charging device outputs electric power for charging a third electric vehicle in response to a third charging request, wherein the third charging request includes third vehicle-usage scheduling information, and the processor further schedules and controls the charging of the first electric vehicle and the third electric vehicle by the first charging device and the charging of the second electric vehicle by the second charging device according to the first charging request, the second charging request, the third charging request and the power supply information, such that the charging of the first electric vehicle, the third electric vehicle and the second electric vehicle are completed without exceeding the power load capacity to meet the first vehicle-usage scheduling information, the third vehicle-usage scheduling information and the second vehicle-usage scheduling information, respectively.

10. A method for charging management of charging devices for use in a first charging device in a charging group, wherein the charging group comprises the first charging device and a second charging device electrically connected to a power supply equipment, the method comprising:
obtaining power supply information corresponding to the power supply equipment, the power supply information recording a power load capacity of the power supply equipment;
obtaining a first charging request, which requires the first charging device to output power for charging a first electric vehicle, wherein the first charging request includes first vehicle-usage scheduling information;
obtaining a second charging request, which requires the second charging device to output power for charging a second electric vehicle, wherein the second charging request includes second vehicle-usage scheduling information; and
scheduling and controlling the charging of the first electric vehicle by the first charging device and the charging of the second electric vehicle by the second charging device according to the first and second charging requests and the power supply information,
such that the charging of the first electric vehicle and the charging of the second electric vehicle are completed without exceeding the power load capacity to meet the first vehicle-usage scheduling information and the second vehicle-usage scheduling information.

11. The method of claim 10, wherein the first vehicle-usage scheduling information and the second vehicle-usage scheduling information comprise at least one of the following information:
the first vehicle-usage scheduling information records the time when the first electric vehicle is scheduled to be used, and the second vehicle-usage scheduling information records the time when the second electric vehicle is scheduled to be used;
the first vehicle-usage scheduling information records a planned travel distance of the first electric vehicle, and the second vehicle-usage scheduling information records a planned travel distance of the second electric vehicle; and
the first vehicle-usage scheduling information records the demand for the desired charging amount of the first electric vehicle, and the second scheduled vehicle information records the demand for the desired charging amount of the second electric vehicle.

12. The method of claim 10, further comprising:
obtaining first battery information of the first electric vehicle and second battery information of the second electric vehicle; and
determining a remaining battery capacity of the first electric vehicle and a remaining battery capacity of the second electric vehicle based on the first battery information and the second battery information to control and schedule the charging of the first charging device to the first electric vehicle and the charging of the second charging device to the second electric vehicle such that the one with the lower remaining battery capacity between the first electric vehicle and the second electric vehicle is preferentially charged.

13. The method of claim 12, further comprising:
periodically obtaining the remaining battery capacity from one of the first electric vehicle and the second electric vehicle currently being charged and determining whether the remaining battery capacity has reached a battery capacity threshold, and if so, suspending the charging of the one of the first electric vehicle and the second electric vehicle currently being charged, and switching to charge the other one of the first electric vehicle and the second electric vehicle instead.

14. The method of claim 12, further comprising:
determining the remaining battery capacity of the first electric vehicle and the remaining battery capacity of the second electric vehicle based on the first battery information and the second battery information, and if the remaining battery capacity of one of the first electric vehicle or the second electric vehicle is lower than a minimum battery capacity threshold, charging the battery of the one with a remaining battery capacity lower than the minimum battery capacity threshold first to reach the minimum battery capacity threshold, and then controlling and scheduling the charging of the first charging device to the first electric vehicle and the charging of the second charging device to the second electric vehicle.

15. The method of claim 10, wherein the power supply information further includes the time difference electricity price applicable to the power supply equipment, and the method further comprises:
scheduling and controlling the first charging device to charge the first electric vehicle and the second charging device to charge the second electric device to minimum a total electricity price of the electric power used by the first charging device for charging the first electric vehicle and the second charging device for charging the second electric vehicle.

16. The method of claim 10, further comprising:
obtaining charging fee information of the first charging device and the second charging device, and performing one of the following steps:
calculating charging amount corresponding to the first charging request and the second charging request according to the charging information, and transmitting the calculated charging amount of the second charging request to the second charging device to charge accordingly; and
calculating the charging amount corresponding to the first charging request according to the charging information and transmitting the charging information to the second charging device for the second charging device to calculate the charging amount corresponding to the second charging request.

17. The method of claim 10, wherein the first charging request further includes first user information recording a user priority level corresponding to the first electric vehicle, and the second charging request further includes second user information recording a user priority level corresponding to the second electric vehicle, and the method further comprises:
comparing the user priority levels corresponding to the first electric vehicle and the second electric vehicle according to the first user information and the second user information, and scheduling and controlling the first charging device to charge the first electric vehicle and the second charging device to charge the second electric vehicle, such that the one with a higher priority between the first electric vehicle and the second electric vehicle is preferentially charged.

18. The method of claim 10, wherein the first charging device comprises a plurality of charging connectors, and when the first electric vehicle is electrically connected with one of the plurality of charging connectors, a third electric vehicle is electrically connected with another one of the charging connectors, and the method further comprises:
obtaining a third charging request for requesting the first charging device to output electric power for charging the third electric vehicle, wherein the third charging request includes third vehicle-usage scheduling information; and
scheduling and controlling the charging of the first electric vehicle and the third electric vehicle by the first charging device and the charging of the second electric vehicle by the second charging device according to the first charging request, the second charging request, the third charging request and the power supply information, such that the charging of the first electric vehicle, the third electric vehicle and the second electric vehicle are completed without exceeding the power load capacity to meet the first vehicle-usage scheduling information, the third vehicle-usage scheduling information and the second vehicle-usage scheduling information, respectively.
